(19) United States
(12) Patent Application Publication
(10) Pub. No.: US 2012/0274616 A1
(43) Pub. Date: Nov. 1, 2012

(54) Electrophoretic Display Using Fibers Containing a Nanoparticle Suspension

(75) Inventors: Cliff J. Scribner, San Antonio, TX (US); James D. Oxley, San Antonio, TX (US); Charles K. Baker, San Antonio, TX (US)

(73) Assignee: SOUTHWEST RESEARCH INSTITUTE, San Antonio, TX (US)

(21) Appl. No.: 13/095,087

(22) Filed: Apr. 27, 2011

(51) Int. Cl. G09G 5/00; G09G 3/34

(52) U.S. Cl. 345/205; 345/107

(57) ABSTRACT

A composite textile for generating an electrophoretically driven image. The textile has at least three layers. An outer (relative to an observer of the image) electrode layer is made from a transparent and electrically conductive material. A fibermat layer is under the outer electrode layer, and comprises a mat of one or more fibers, each fiber being transparent and dielectric and having a hollow core that contains a fluid suspension of particles (typically nanoparticles) of at least two color types. A pattern layer is under the fiber mat layer, and has an arrangement of features made from an electrically conductive material. When voltage is applied to the pattern layer, the particles respond by migrating toward the outer electrode or pattern layer, depending on their charge.

### TECHNICAL FIELD OF THE INVENTION

This invention relates to electrophoretic displays, and more particularly to a display generated by electrophoretically driven particles, typically nanoparticles, suspended within fluid-filled fibers.

### BACKGROUND OF THE INVENTION

The terms “electronic paper” and “electronic ink” describe a type of display technology designed to mimic the appearance of ordinary ink on paper. Unlike conventional backlit flat panel displays, electronic paper displays reflect light like ordinary paper. Many of these displays are capable of holding images for long periods of time without drawing electricity, and allow the image to be changed at will of the user.

Electrophoretic displays are one type of electronic paper. An electrophoretic display forms images by using an applied electric field to arrange pigment particles within a dielectric suspension fluid. These particles can be as large as microns, but more typically, the particle size is in the tens to hundreds of nanometer range.

In one implementation of an electrophoretic display, titanium dioxide (light colored) particles are dispersed in a dielectric suspension. Dark-colored dye particles are also added to the suspension, typically along with various agents that are designed to enhance the charge mobility, lifetime and agglomeration characteristics of the particles. This admixture is placed between two parallel and electrically conductive plates having a gap of about 10 to 100 microns. When a proper voltage is applied across the two plates, each particle will migrate electrophoretically to the plate bearing the opposite charge from that of the particles. When the titanium dioxide particles are located at the front (viewing) side of the display, they appear white, because light is scattered back to the viewer. When the dye particles are located at the rear side of the display, they appear dark, because the incident light is absorbed by the dye.

If the display's rear plate (electrode) is divided into pixels, an image can be formed by applying the appropriate voltage to each pixel region. The applied voltage can be used to create a pattern of reflecting and absorbing regions. By electrically addressing the pixels, the display allows an observer to see pattern changes as the electric field is modulated from a positive or negative state. Semi-flexible electronic paper has been developed by making use of plastic substrates and plastic electronics for the front and back plates.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates the various layers of the display.

FIG. 2 is a cross sectional view of the display, showing its operation to generate an image.

FIG. 3 is a microscopic top view of the fibermat layer.

FIG. 4 is a cross sectional view of a fiber sheath used for the fibermat layer.

FIG. 5 is a representative illustration of equipment for performing a coaxial electrospinning process, which can be used to make the fibers of the fibermat layer.

FIG. 6 illustrates an example of the display, activated to generate an image.

FIG. 7 illustrates an alternative embodiment of the fibermat of FIG. 1.

### DETAILED DESCRIPTION OF THE INVENTION

The following description is directed to a nanocomposite display that uses principles derived from the various technologies of electrophoresis, electro-spinning, microencapsulation and electronic paper. The display is generated by electrophoretically driving particles suspended in fluid-filled fibers. The fibers typically have a diameter in the micrometer range, and the particles are typically nanoparticles. The display may be rigid or flexible, depending on the materials used. Ideally, the display is powered within the nano-amp per square centimeter region, and has the ability to produce a spatial color state change in thirty-seconds or less.

As explained below, a typical configuration of the display is as a flat two-dimensional “display textile”. The term “display textile” as used herein, generally but not necessarily, means a display that is both flexible and two-dimensional. If flexible, the display textile may further be “fabric-like” in the sense that the display may sufficiently flexible to be folded and bent without damage, similar to clothing fabric. A likely application of the display is as a wearable textile having electrically addressable spatial patterns across a substrate surface.

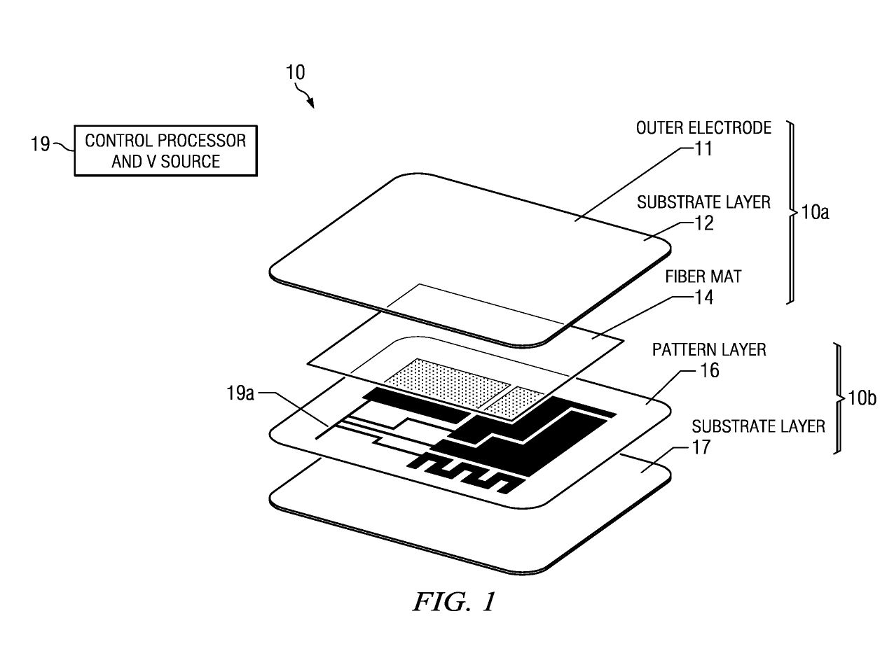

FIG. 1 illustrates the various layers of the nanocomposite display 10. The embodiment of FIG. 1 is especially suitable for fabrication with materials that provide a flexible two-dimensional display textile. As explained in further detail below, display 10 is driven electrophoretically using a DC voltage, which provides the capability to produce color changes via the movement of charged particles within a fibermat layer 14.

Display 10 has five very thin layers. In one embodiment, display 10 may be fabricated as two composite “shells”, an “outer shell” 10a and an “inner shell” 10b. These two shells are separately fabricated and then attached together. Outer shell 10a comprises an outer electrode layer 11, outer substrate layer 12, and fibermat layer 14. Inner shell 10b comprises an inner electrode (pattern) layer 16 and an inner substrate layer 17. A control interface 19a provides an electric connection to the pattern layer 16 from a power source and a control processor 19.

Other fabrication techniques are possible. Because outer substrate layer 12 and inner substrate layer 17 may be the same type of material, with some fabrication techniques, these substrate layers 12 and 17 may be equivalent to a single substrate with layers 14 and 16 embedded or otherwise fabricated in that substrate.

The display 10 has an “upper” surface, relative to a viewer of the display. In the case of wearable clothing, this upper surface would be the outer surface of the clothing. In general, upper electrode layer 11 is disposed at or near the top surface of the substrate, fibermat layer 14 is embedded in the substrate, and pattern layer 16 is under the fibermat layer 14 typically at or near the bottom surface of the substrate. For purposes of this description, outer electrode layer 11 and outer substrate layer 12 are “transparent” in the sense that they pass sufficient light to provide a viewable image resulting from the activation of nanoparticles in the fibermat layer 14.

Outer electrode layer 11 is electrically conductive and transparent. Electrode layer 11 provides one end of a closed path for an electric field to influence the movement of charged nanoparticles suspended within the fibermat layer 14. Typically, electrode layer 11 serves as a ground plane.

Outer electrode layer 11 typically has a thickness that is about 150 microns or less. An example of a suitable material for layer 11 is a stainless steel fabric grid, such as a mesh having a 0.0012 inch thread size with 88% optical transparency. In this case, the material that comprises outer electrode layer 11 is not itself transparent but its mesh configuration provides sufficient transparency to view the addressable fibermat layer 14. An example of specifications for a conductive grid is mesh having a 5 um line and 200 um pitch.

Other possible materials for outer conductive layer 11 are a layer of a transparent and electrically conductive polymer or other material. A specific example of such a material is poly-ethylenedioxythiophene (PEDOT:PSS).

Outer substrate layer 12 is dielectric and transparent. Typically, layer 12 is a silicon-based polymer layer. Specific examples of suitable materials for layer 12 are uv-curable silicone, silicone acrylates, urethanes, PDMS or copolymers. A typical thickness of layer 12 is 0.5 millimeters or less.

Fibermat layer 14 comprises a fibermat made from one or more dielectric fibers that are typically about twenty-five to one-hundred-fifty micrometers in diameter. The fiber is a “mat” in the sense that it need not be woven; in general, one or more fibers are bent or folded in a plane to result in a thin flat layer of the fiber(s). The fibermat layer 14 typically has a thickness less than 0.4 millimeters. The fibermat may have varying degrees of density, depending on the desired display resolution.

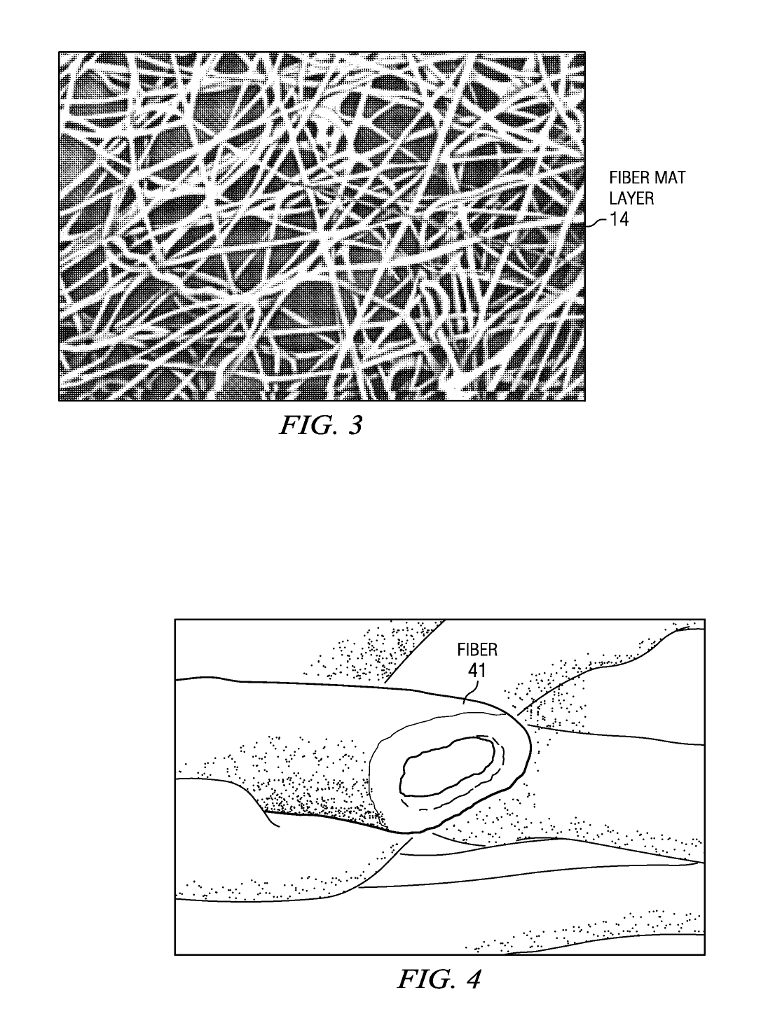

A typical embodiment of fibermat layer 14 has coaxially electrospun polymer fibers, with an inner core composed of a transparent dielectric fluid and two types of permanent but oppositely charged colored nanoparticles (50 to 500 nanometer diameter) that are able to freely move within the colloidal suspension fluid. The nanoparticles are made from combinations of pigment, dye, polymer or surfactant, with the combination designed to enhance the charge mobility, lifetime and agglomeration characteristics of the display. Fibermat layer 14 is discussed in further detail below in connection with FIGS. 3, 4 and 7.

As stated above, an outer shell 10a may be fabricated separately from an inner shell 10b, and then the two shells attached. The composite outer shell 10a may be fabricated by adhering the fibermat layer 14 to the underside of layer 12. The electrode layer 11 may be applied to, deposited on, or embedded into the exposed portion of outer substrate layer 12.

Pattern layer 16 is a pattern of electrically conductive features and connections that are printed on an inner substrate layer 17. The printing can be contact, screen or ink jet printing. Another suitable material is a metalized fabric having the desired pattern. Pattern layer 16 provides the means to move the nanoparticles within fibermat 14, and to thereby address the display. This layer typically has a thickness of about 150 microns or less.

In one embodiment of pattern layer 16, a predetermined pattern of features (asymmetrical or symmetrical shapes, characters, etc. and their interconnections) is printed. The printing may be with an electrically conductive polymer such as PEDOT:PSS, onto inner substrate layer 17 to provide the means to address the display via the pattern. Examples of other suitable materials for the features of pattern layer 16 are electrically conductive inks, conductive copper tape or a metalized fabric having patterns predisposed on its surface.

Inner substrate layer 17 is a flexible structural layer, similar to outer substrate layer 12. It is dielectric and typically also transparent, and may be made of a similar if not identical material as substrate layer 12. Layer 17 provides the means to support the flexible pattern features of pattern layer 16. A typical thickness of substrate layer 17 is 0.5 mm or less.

A control interface 19a functions as the bridge for electrical input to the patterns that address specific areas of the display. A control unit 19 provides an activation signal that activates pattern layer 16 to result in the desired image. The complexity of control unit 19 can vary, and could include processing and memory devices for storing and generating complex images or for receiving data representing images to be generated.

Operation

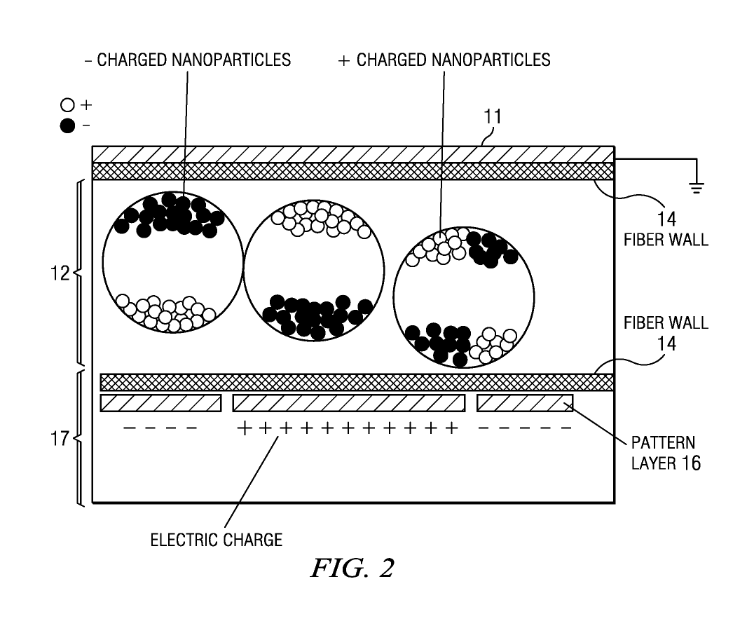

FIG. 2 is a cross sectional view of the display, showing how its nanoparticles are electrically charged to generate an image. FIG. 2 further shows how, when the fibers are configured as a fibermat as in FIG. 1, substrate layers 12 and 17 may be equivalently a single substrate layer, with the upper electrode layer 11, fibermat layer 14, and pattern layer 16 being arranged on or in the substrate in that order. The pattern features spatially distributed on layer 16 may be positively or negatively charged via the control interface 19a.

In the example of FIG. 2, fibermat layer 14 has its nanoparticles microencapsulated within fluid-filled spheres, with the spheres being suspended in a dielectric fluid that fills the fiber core. As explained below, in other embodiments, the nanoparticles may be suspended in the dielectric fluid without being encapsulated.

From the observer's point of view, a negative charge on a given pattern feature of pattern layer 16 tends to move the black colored negatively charged particles toward the opposed ground electrode layer 11. This negative feature pattern charge simultaneously attracts the white colored positively charged toward the feature pattern of layer 16. The opposite action is also true as shown in the fluid-filled center sphere. A third possibility is also shown, where there may be some portion of a microencapsulated sphere that is split partially between two differently charged features. In this case, some portion of each type of particle may move toward the ground electrode layer 11 or feature pattern layer 16, respectively.

The strength of the applied voltage, its duration, and its polarity are all parameters used to move the particles and to create a color shift and/or change as desired. Complex waveforms could be used to move particles as needed to produce shades of color or a full change of color, using the pattern layer.

It should be understood that the method illustrated in FIG. 2, of electrophoretically driving particles suspended in a core of a fiber, is not limited to two-dimensional textiles. The same concepts could be applied to any configuration of such fibers having appropriate circuitry for the outer and pattern electrodes. Typically, the configuration of fibers is two-dimensional (planar). However, the configuration of fibers could be such that the display is “linear”, i.e., long and thin, and a display could be generated from a single fiber.

Fibermat Layer

FIG. 3 is a microscopic top view of one embodiment of fibermat layer 14. FIG. 4 is a cross sectional view of the fiber sheath, such as might be part of a fiber 41 used for fibermat layer 14. In the example of FIGS. 3 and 4, each fiber 41 is a continuous fiber sheath with a hollow core, and in actual implementation contains a nanoparticle suspension as described above. An alternative embodiment, in which the fibers have hollow sections rather than a continuous hollow core, is described below in connection with FIG. 7.

Fibermat layer 14 may comprise coaxially electro-spun polymer fibers 41. Each fiber 41 has a transparent outer sheath, an inner core composed of a transparent dielectric fluid, and two types of permanent but oppositely charged colored nanoparticles (pigment) that are able to freely move within the core fluid. The suspended nanoparticles within the fiber 41 represent the addressable color aspect of the design. As explained below, other embodiments, such as particles of one color suspended in a dye-colored fluid, are possible.

An example of a suitable fiber 41 is a co-extruded hollow fiber having an outer diameter in the range of 50-150 microns. In the example of FIG. 4, the outer diameter of the formed fiber 41 is approximately 30 to 40 micrometers with an inner core geometry of about 20 to 25 micrometers. Production versions of fibermat layer 14 are not limited to these fiber sizes.

The outer sheath of fiber 41 is made from a dielectric and transparent material. Examples of possible suitable materials are PS polystyrene, ethyl cellulose, ethyl vinyl acetate, Saran, shellac, PDMS and possibly copolymers and blends. Additional materials that may prove to be suitable are PET, PES, PE, PP, PEK, and nylon.

The nanoparticles to be positively charged are expected to be in the range of 50 nm-500 nm. For white colored particles, an example of a suitable material is titanium dioxide (TiO2) and various TiO2 based particles.

The nanoparticles to be negatively charged are expected to be in the range of 50 nm-600 nm. For black nanoparticles, examples of suitable materials are carbon black particles or polymer-based carbon black ink toner particles.

In the above example, the fibers of fibermat layer 14 contain nanoparticles having two color types (light and dark). This may be referred to as a “two particle” embodiment, in which the dielectric fluid admixture has a second particle to serve as a contrast agent.

In a “single particle” embodiment, the fibers of fibermat layer 14 may contain a dielectric fluid admixture with particles of one type and color and with a colored dye to provide the contrast color. As a specific example, polystryrene and AOT (dioctyl sodium sulfosuccinate) can be dissolved in a solvent to obtain a low viscosity stable dispersion. Oil-blue N is added to color the dispersion, and will provide high contrast white and blue images. As an alternative to oil-blue N, oil-red EGN could be used for white and red images.

The core fluid is a dielectric and transparent material. Examples of possible suitable materials are mineral oil, ISOPAR M (Exxon), isoparaffin HC, DOW 200 (DOW), PDMS silicone oil, PDM-7040 (Gelest), PMSO silane and fluorinated oil (Krytox).

For fabricating fibermat layer 14, one technique is microencapsulating the nanoparticles in a protective dielectric material in a fluid-filled sphere prior to performing the electro-spinning fiber process. In a second approach, the nanoparticle-dielectric fluid admixture will remain unprotected as the fiber is formed. Either of these types of fibers is formed into a mat or possibly individual “whiskers” or pieces of an arbitrary or predefined length. The fiber-whisker embodiment may have sealed ends to prevent leakage of the nanoparticle admixture. The desired flexibility of the fibers may vary depending on their length, that is, shorter fibers may not need to be as flexible as longer fibers to achieve a “fabric-like” textile.

Electrospinning Process

Electrospinning is a process having the capability, in principle, of generating large quantities of very small fibers having structural dimensions from microns well into the tens of nanometers scale. A typical setup for electrospinning consists of a spinneret with a metallic needle, a syringe pump, a high-voltage power supply, and a grounded plane collector. A polymer, solution gel or composite solution is loaded into the syringe and this viscous liquid is driven to the needle tip by a syringe pump, thus forming a droplet at the tip. When the proper high voltage is applied to the metallic needle, the droplet is then stretched into a structure called a Taylor cone and finally into an electrified jet. This jet is elongated and whipped continuously by electrostatic repulsion until it is deposited on the collector.

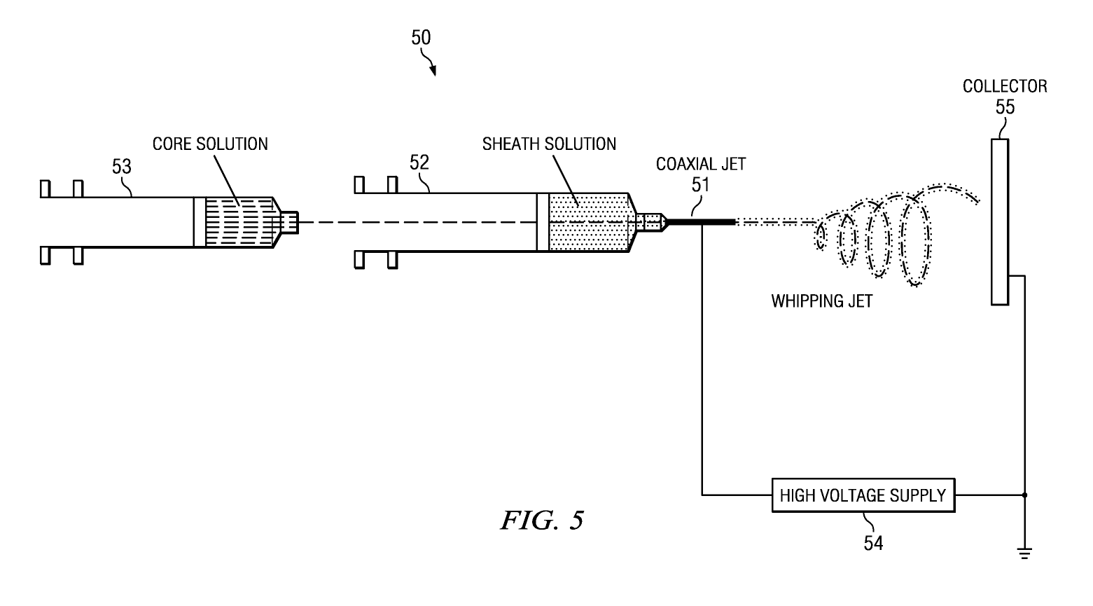

FIG. 5 is representative of equipment 50 for performing a coaxial electrospinning process, which can be used to make the fibers 41 of fibermat layer 14. By replacing the single capillary with a coaxial spinneret 51, equipment 50 can be used to fabricate core-sheath or hollow fibers. The spinneret 51 has both a sheath solution syringe 52 and a core solution syringe 53. The equipment further includes a high-voltage power supply 54 and a grounded plane collector 55.

A major challenge of coaxial electrospining is the need to not only synchronize each of the distinct core-sheath solution flow rates but to also produce a Taylor cone within a Taylor cone in order to form the finished core-sheath fiber composite. The best results seem to occur by co-spinning two immiscible solutions, followed by cross-linking and stabilization of a polymer sheath. However, closed surface fluid-filled fibers 41 have been successfully formed using core materials of PDMS silicone, Krytox fluorinated oils or mineral oil despite negative miscibility constraints.

Experimental efforts have focused on fabricating fibers with ethyl cellulose sheath material, using fluorinated oils, PDMS silicon or mineral oil for the core material. Ethyl cellulose sheath material has been used principally due to its good film forming properties and common use in the encapsulation industry.

For generating the fiber sheath, experimental success has been achieved using low viscosity ethyl cellulose at an adjusted concentration with a solvent, such that, when the electric field is applied a conical jet is formed. The solvent evaporates rapidly and the sheath solidifies producing a continuous fiber. This electrospinning process can be used to provide random non-woven fibermats having hollow but fluid-filled cores.

Display

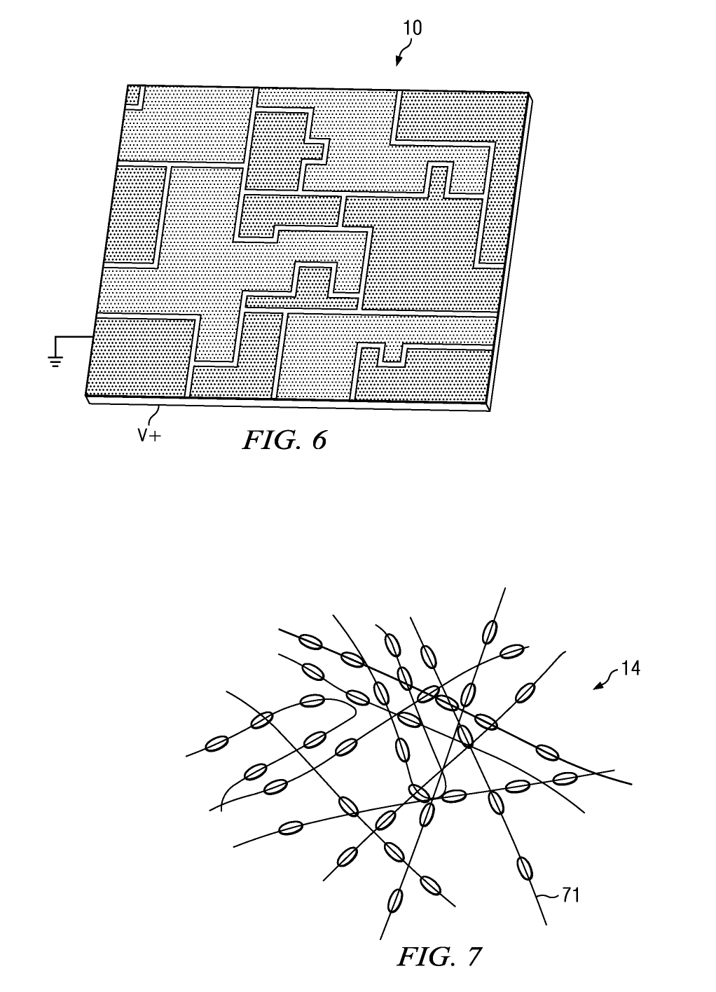

FIG. 6 illustrates an example of display 10, activated to generate an image. In this embodiment, the outer surface of the outer substrate layer 12, into which the outer electrode layer 11 is embedded, comprises the display surface.

The pattern lay-out (as determined by pattern layer 16) and color scheme (as determined by the nanoparticles in the fibermat layer 14) are arbitrary. Typical feature sizes might be in the range of 1/16 of an inch to 1½ inches. The “pattern” could be any type of image or alphanumeric characters.

One goal is to construct a display textile having physical properties similar to a thin sheet of medical grade silicone rubber with a hardness of about 50 or 60 on the A durometer scale. This grade of silicone has a tensile strength of about 1300 pounds per square inch (psi) and an usable temperature range from minus sixty-five to about four-hundred (−65 to 400° F.) degrees Fahrenheit.

For wearable applications, display 10 may have an overall thickness of less than one millimeter. Ideally, display 10 may be made in large sheets, suitable for fashioning into clothing or other wearable pieces.

“String of Pearls” Fibermat

FIG. 7 illustrates an alternative embodiment of fibermat layer 14, in which fibermat layer 14 has a “string of pearls” configuration. In other words, rather than a uniform hollow cross section, each fiber 71 is a series of hollow sections, such as rounded capsules, connected by thin strands of the fiber sheath material. The connecting strands may be of a smaller diameter and need not be hollow. The nanoparticles that are activated for display and the suspension fluid are contained in the hollow sections.

Various coextrusion methods may be used to fabricate fibers 71. For example, an electrohydrostatic coextrusion method might use syringes similar to that of FIG. 5. For fibers 71, both a core solution and a sheath solution are extruded with an electrohydrostatic induced flow. A resulting Taylor cone produces droplets of core material encapsulated by the sheath material, and connected by strands of the sheath material.

What is claimed is:

1. A composite textile for generating an electrophoretically driven image, comprising:
a substrate layer, made from a transparent and dielectric material, having an inner surface and an outer surface relative to the display;
an outer electrode layer, made from a transparent and electrically conductive material, adhered to or embedded on or near the outer surface of the substrate layer;
a fibermat layer, comprising a mat of one or more fibers, each fiber having a sheath made from transparent and dielectric material and having a hollow core or hollow sections containing a fluid suspension of particles of at one color type, the fibermat layer being adhered to or embedded in the substrate layer under the outer electrode layer; and
a pattern layer having an arrangement of features made from an electrically conductive material, the pattern layer being adhered to or embedded in the substrate layer under the fibermat layer.

2. The textile of claim 1, wherein the textile is non-rigid.

3. The textile of claim 1, wherein the textile is sufficiently flexible to be “fabric-like”.

4. The textile of claim 1, wherein the outer electrode layer is made from an electrically conductive mesh.

5. The textile of claim 1, wherein the outer electrode layer is made from a electrically conductive and transparent polymer.

6. The textile of claim 1, wherein the substrate layer is made from a polymer.

7. The textile of claim 1, wherein the fibermat layer is made from co-axially electrospun fibers.

8. The textile of claim 1, wherein the fibers have an outer diameter of less than 150 micrometers.

9. The textile of claim 1, wherein the at least one color type of particles is at least partially titanium dioxide.

10. The textile of claim 1, wherein the at least one color type of particles is at least partially carbon black.

11. The textile of claim 1, wherein the pattern layer is made from a conductive fabric.

12. The textile of claim 1, wherein the substrate has an upper layer and an inner layer.

13. The textile of claim 1, wherein the fluid suspension has particles of two color types.

14. The textile of claim 1, wherein the fluid suspension has particles of one color type and also contains a dye.

15. A method of generating an electrophoretically driven display, comprising:
providing one or more transparent and dielectric fibers, each fiber having a sheath made from transparent and dielectric material and having a hollow core or hollow sections containing a fluid suspension of particles of at one color type;
applying an electrical charge to an outer electrode, made from a transparent and electrically conductive material, located above the fibers; and
applying an opposing electrical charge to a pattern layer having an arrangement of features made from an electrically conductive material, located under the fibers.

16. The method of claim 15, wherein the one or more fibers are configured in a two-dimensional fibermat.

17. The method of claim 15, wherein the fluid suspension has particles of two color types.

18. The method of claim 15, wherein the fluid suspension has particles of one color type and also contains a dye.

19. A composite textile for generating an electrophoretically driven image, comprising:
an outer electrode layer, made from a transparent and conductive material;
a fibermat layer under the outer electrode layer, comprising a mat of one or more fibers, each fiber having a sheath made from transparent and dielectric material and having a hollow core or hollow sections containing a fluid suspension of particles of at one color type; and
a pattern layer under the fibermat layer, having an arrangement of features made from a conductive material.

20. The textile of claim 19, further comprising a substrate layer, made from a transparent and dielectric material, wherein the fibermat is within the substrate layer.

21. The textile of claim 19, wherein the textile is non-rigid.

22. The textile of claim 19, wherein the textile is sufficiently flexible to be “fabric-like”.
